(19) United States
(12) Patent Application Publication
(10) Pub. No.: US 2026/0077695 A1
(43) Pub. Date: Mar. 19, 2026

(54) AUTOMOTIVE FLOOR MAT WITH POCKET ON ONE END THAT GOES UNDERNEATH SEAT TO CATCH WATER AND DEBRIS

(71) Applicants: Dennis F. Chavours, Springfield, IL (US); Taylor Chavours, Houston, TX (US)

(72) Inventors: Dennis F. Chavours, Springfield, IL (US); Taylor Chavours, Houston, TX (US)

(21) Appl. No.: 19/314,348

(22) Filed: Aug. 29, 2025

Related U.S. Application Data
(60) Provisional application No. 63/696,132, filed on Sep. 18, 2024.

(51) Int. Cl. B60N 3/04

(52) U.S. Cl. CPC B60N 3/048

(57) ABSTRACT

An automotive floor mat with a pocket to catch water and debris is disclosed. The mat includes a flexible mat body and an integrated pocket that creates a collection chamber for containing accumulated water and debris. The flexible construction allows users to roll debris and water toward the pocket where it can be contained until the mat is removed for cleaning. The pocket extends underneath (or to the side) of a vehicle seat to maximize collection capacity while utilizing otherwise unused space. This design prevents spillage during mat removal and provides enhanced containment compared to conventional automotive floor mats.

### CROSS-REFERENCE TO RELATED APPLICATION

This application claims the benefit of U.S. Provisional Patent Application No. 63/696,132, filed Sep. 18, 2024, entitled “AUTOMOTIVE FLOOR MAT WITH POCKET ON ONE END THAT GOES UNDERNEATH SEAT TO CATCH WATER AND DEBRIS,” which is incorporated herein by reference in its entirety.

### FIELD OF THE INVENTION

The present invention relates to automotive floor mats, and more particularly to an automotive floor mat with a pocket on one end that goes underneath a seat to catch water and debris.

### BACKGROUND OF THE INVENTION

Conventional automotive floor mats are designed to protect the vehicle's carpeting and flooring from dirt, water, and debris tracked in by occupants. However, these traditional mats suffer from significant limitations that compromise their effectiveness and user convenience.

Conventional car mats have problems in that they often trap large amounts of liquid and dirt without providing an effective means for containment or removal. When water and debris accumulate on these flat mats, the liquid can easily spill over the edges during removal, creating mess and potentially damaging the vehicle's interior. Additionally, conventional mats are typically rigid and require careful handling during removal to prevent spillage, making routine cleaning cumbersome and ineffective. Furthermore, traditional automotive floor mats lack any integrated collection system for liquids and debris. When users attempt to clean these mats, the accumulated water and dirt must be carefully balanced and maneuvered out of the vehicle, often resulting in spillage back onto the vehicle floor or outside the vehicle.

There is therefore a need for an improved automotive floor mat that provides enhanced containment of water and debris while facilitating easier and more effective cleaning and maintenance.

### SUMMARY OF THE INVENTION

The present invention addresses the shortcomings of conventional automotive floor mats by providing an automotive floor mat with a pocket to catch and contain water and debris.

In accordance with one embodiment of the present invention, there is provided an automotive floor mat comprising a flexible mat body having a first end and a second end, and a pocket formed at the second end of the mat body. The pocket is configured to extend underneath a vehicle seat when the mat is installed, creating a collection area for water and debris. The flexible nature of the mat allows a user to roll or direct debris and water toward the pocket for containment and subsequent removal.

The automotive floor mat of the present invention substantially covers the carpeting and/or flooring of an automobile with a mat that effectively keeps out moisture and dirt while providing a convenient collection and disposal system. The pocket design prevents spillage during mat removal and cleaning, representing a significant improvement over conventional automotive floor mats.

The flexible construction of the mat enables users to manipulate the mat surface to direct accumulated water and debris toward the pocket, where it can be contained until the mat is removed for cleaning.

These and other features, aspects, and advantages of the present invention will become better understood with reference to the following drawings, description, and claims.

### BRIEF DESCRIPTION OF THE DRAWINGS

The invention will be more fully understood from the following detailed description taken in conjunction with the accompanying drawings, in which:

FIG. 1 is a perspective view of an automotive floor mat with pocket in accordance with a preferred embodiment of the present invention;

FIG. 2 is a top elevation view of the automotive floor mat with pocket showing the pocket configuration;

FIG. 3 is a cross-sectional view taken along line 3-3 in FIG. 2;

FIG. 4 is a perspective view of an alternative embodiment of the automotive floor mat with pocket; and

FIG. 5 is a top elevation view of the alternative configuration showing an alternative pocket.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an automotive floor mat with an integrated pocket to catch water and debris, offering significant improvements in functionality and user convenience over conventional automotive floor mats.

### Primary Embodiment

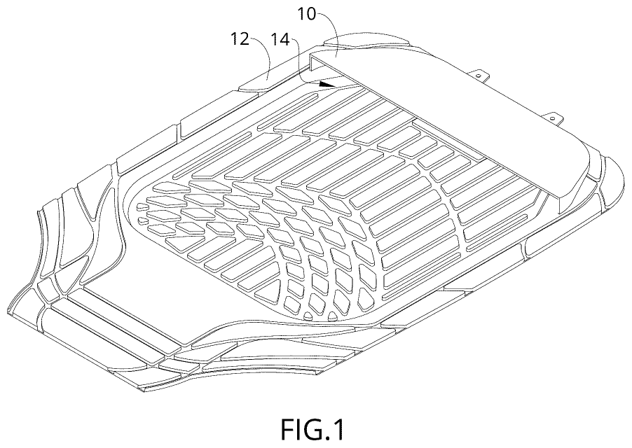

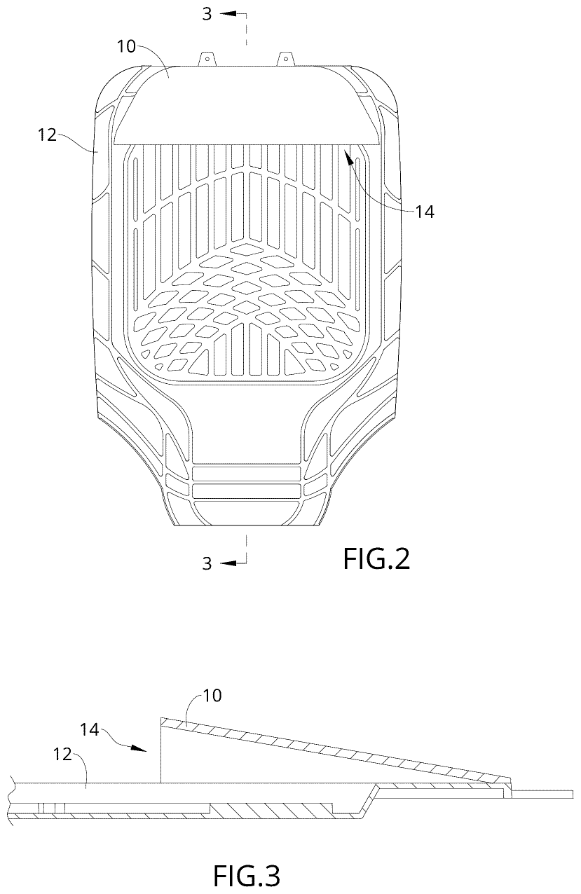

Referring now to FIGS. 1-3, there is shown an automotive floor mat in accordance with a preferred embodiment of the present invention. The automotive floor mat comprises a floor mat body 12 having a substantially planar main surface for substantially covering the carpeting and/or flooring of an automobile. The mat body 12 is constructed of flexible material that allows for manipulation and rolling of debris toward a collection area.

A pocket 10 is integrally formed at one end of the floor mat body 12. The pocket 10 creates a three-dimensional collection chamber 14 that extends upward from the main surface of the mat body 12. The collection chamber 14 serves as a collection area for water and/or debris that accumulates on the mat surface.

The pocket 10 is positioned and dimensioned such that when the automotive floor mat is installed in a vehicle, the pocket 10 extends underneath (or substantially underneath) a vehicle seat. This positioning serves multiple functions: it maximizes the collection area available for debris and water while utilizing otherwise unused space beneath the seat, and it provides a discrete location for the collection chamber that does not interfere with occupant foot placement.

The flexible nature of the floor mat body 12 enables users to roll, fold, or otherwise manipulate the mat surface to direct accumulated water and debris toward the pocket 10 and collection chamber 14. This represents a significant improvement over conventional rigid mats that require careful balancing during removal to prevent spillage.

### Alternative Embodiment

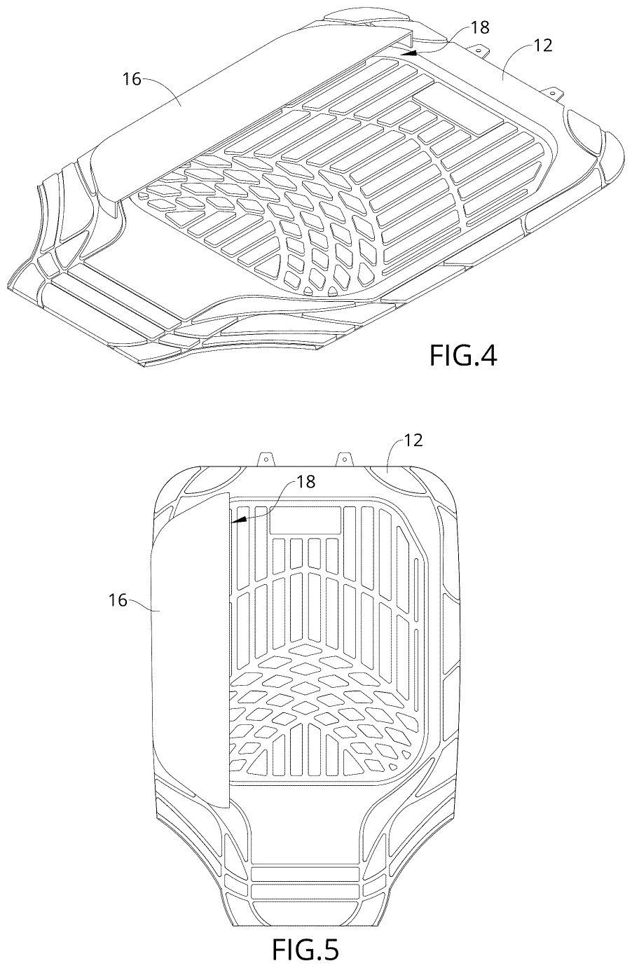

Referring now to FIGS. 4-5, there is shown an alternative embodiment of the automotive floor mat 12. In this embodiment, the mat includes an alternative pocket 16 that creates an alternative collection chamber 18 that is positioned on one side of the floor mat 12 (rather than at one end as in the mat shown in FIGS. 1-3). The alternative pocket 16 may have different dimensional characteristics or construction features compared to pocket 10, while maintaining the same functional principle of providing a collection area for water and debris.

The alternative pocket 16 may incorporate different sidewall angles, depth dimensions, or opening configurations to optimize performance for specific vehicle types or user preferences. The alternative collection chamber 18 provides the same containment function as the primary embodiment while potentially offering enhanced capacity or improved drainage characteristics.

### Construction and Materials

The automotive floor mat of the present invention can be manufactured using injection molding techniques with compliant materials including, but not limited to, rubberized materials, thermal plastics, nylon, rubber, PVC, and elastomeric compounds. Any suitable injection molded material that provides the necessary flexibility and durability characteristics can be used to manufacture the mat body 12 and integrated pocket 10 or alternative pocket 16.

The choice of material should provide sufficient flexibility to allow manipulation of debris toward the pocket while maintaining structural integrity and resistance to automotive fluids, temperature variations, and repeated use. The material should also provide appropriate surface characteristics for easy cleaning and maintenance.

### Operation and Advantages

In operation, the automotive floor mat is positioned within a vehicle such that the main surface of the mat body 12 substantially covers the desired floor area, and the pocket 10 extends underneath a seat (or at the side of the seat for pocket 16). As water and debris accumulate on the mat surface during normal use, the flexible construction allows the user to periodically roll or direct this material toward the pocket 10/16 for collection in the collection chamber 14/18.

When cleaning is required, the entire mat can be removed from the vehicle with confidence that accumulated water and debris will remain contained within the pocket 10/16, eliminating the spillage problems associated with conventional mats. The collected material can then be emptied from the pocket 10/16 in a controlled manner, and the mat can be cleaned and reinstalled.

This design provides several significant advantages over conventional automotive floor mats:
Spillage Prevention: The integrated pocket design prevents spillage during mat removal and handling, eliminating mess and protecting vehicle interiors.
Enhanced Collection: the Three-dimensional Pocket Void Provides a Dedicated collection area that can hold substantially more liquid and debris than the surface of a conventional flat mat.
Improved Usability: The flexible construction enables active management of debris and water, allowing users to direct material toward the collection area rather than simply allowing it to accumulate randomly.
Space Efficiency: The pocket utilizes otherwise unused space underneath vehicle seats, maximizing collection capacity without interfering with occupant space.
Easy Maintenance: The contained collection system simplifies cleaning and maintenance compared to conventional mats that require careful handling to prevent spillage.

### Variations and Modifications

The claimed invention differs substantially from existing automotive floor mats. While there are many variations of floor mats for automobiles, none incorporate a pocket at one end specifically designed to catch water and debris while extending underneath a seat for optimal positioning and space utilization.

Various modifications and adaptations of the described embodiments will be apparent to those skilled in the art without departing from the spirit and scope of the invention. For example, the pocket dimensions, shape, or positioning can be modified to accommodate different vehicle types or user preferences. The mat body dimensions and surface texturing can be varied to optimize performance for specific applications.

The pocket construction can incorporate drainage features, removable liners, or other enhancements to facilitate cleaning and maintenance. Multiple pockets could be incorporated in larger mat designs, or the pocket could be formed as a removable component for separate cleaning.

It should be understood, of course, that the foregoing relates to exemplary embodiments of the invention and that modifications may be made without departing from the spirit and scope of the invention as set forth in the following claims.

What is claimed is:

1. An automotive floor mat comprising:
a flexible mat body having a first end and a second end, said mat body configured to cover a floor area of a vehicle; and
a pocket formed at said second end of said mat body, said pocket defining a collection chamber and configured to extend underneath a vehicle seat when said mat is installed in said vehicle, whereby water and debris accumulated on said mat body can be directed toward said pocket for containment.

2. The automotive floor mat of claim 1, wherein said flexible mat body allows manipulation to roll debris and water toward said pocket.

3. The automotive floor mat of claim 1, wherein said pocket is integrally formed with said mat body.

4. The automotive floor mat of claim 1, wherein said mat body is constructed from injection molded material selected from the group consisting of rubber, PVC, elastomer, nylon, and thermal plastic.

5. The automotive floor mat of claim 1, wherein said pocket extends upward from a main surface of said mat body to create said collection chamber.

6. The automotive floor mat of claim 1, wherein said pocket is positioned to utilize space underneath said vehicle seat that is otherwise unused.

7. The automotive floor mat of claim 1, wherein said flexible mat body enables directional movement of accumulated debris toward said pocket through user manipulation.

8. An automotive floor mat system comprising:
a mat body having a substantially planar main surface configured to protect vehicle flooring;
a collection chamber formed at one end of said mat body, said collection chamber defining an internal void space; and
wherein said mat body is sufficiently flexible to permit rolling of debris toward said collection chamber, and said collection chamber is dimensioned to extend underneath a vehicle seat when installed.

9. The automotive floor mat system of claim 8, wherein said collection chamber prevents spillage of contained water and debris during mat removal from said vehicle.

10. The automotive floor mat system of claim 8, wherein said mat body and said collection chamber are formed as a unitary structure through injection molding.
